(19) United States
(12) Patent Application Publication
(10) Pub. No.: US 2023/0217431 A1
(43) Pub. Date: Jul. 6, 2023

(54) METHOD FOR TRANSMITTING SCHEDULING REQUEST, APPARATUS, AND COMPUTER READABLE STORAGE MEDIUM

(71) Applicant: Beijing Xiaomi Mobile Software Co., Ltd., Beijing (CN)

(72) Inventor: Xiandong DONG, Beijing (CN)

(21) Appl. No.: 17/999,824

(22) PCT Filed: May 27, 2020
(86) PCT No.: PCT/CN2020/092559

§ 371 Date: Nov. 23, 2022

(51) Int. Cl. H04W 72/1268; H04W 72/56

(52) U.S. Cl. CPC H04W 72/1268; H04W 72/56

(57) ABSTRACT

A method for sending a scheduling request comprises: obtaining numbers for at least two configured SRs and a priority level for each SR; in response to a time domain overlap existing between a physical uplink control channel (PUCCH) resource for K SRs in the at least two SRs and a PUCCH resource for uplink control information (UCI), determining SR information to be transmitted according to the priority levels for the K SRs, wherein the K is a positive integer greater than one; and sending the SR information to be transmitted.

### BACKGROUND

In a 5G system, there are service types that require high reliability and low latency (i.e., ultra-reliability low latency communication (URLLC) service) and service types that do not require high reliability and low latency but require a relatively large data transmission rate (i.e., enhanced mobile broadband (eMBB) service).

### SUMMARY

In a first aspect, a method for transmitting a scheduling request (SR) is provided, and the method includes: obtaining numbers of at least two configured SRs and a priority level for each SR; in response to a time domain overlap existing between a physical uplink control channel (PUCCH) resource for K SRs in the at least two SRs and a PUCCH resource for uplink control information (UCI), determining SR information to be transmitted according to the priority levels for the K SRs, where K is a positive integer greater than one; and sending the SR information to be transmitted.

In a second aspect, user equipment (UE) is provided, and the user equipment includes a memory and a processor, where the memory and the processor are communicatively coupled,

a computer program is stored in the memory; and

the processor is used for executing the method for transmitting a scheduling request, where the method for transmitting a scheduling request is described in the first aspect, when the computer program is run.

In a third aspect, a non-transitory computer-readable storage medium is provided, where a computer program is stored in the non-transitory computer-readable storage medium, and when the computer program is run by user equipment, the user equipment executes the method for transmitting a scheduling request, where the method for transmitting a scheduling request is described in the first aspect.

Additional aspects and advantages of the present disclosure will be partially given in the following description, and will become apparent from the following description or be learned from the practice of the present disclosure.

### BRIEF DESCRIPTION OF THE DRAWINGS

In order to more clearly describe the technical solutions in the examples of the present disclosure, the following will briefly introduce drawings that need to be used in the description of the examples of the present disclosure.

FIG. 1 is a schematic flow diagram of a method for transmitting a scheduling request according to an example of the present disclosure;

FIG. 2 is a schematic flow diagram of a method for transmitting a scheduling request according to another example of the present disclosure;

FIG. 3 is a schematic structural diagram of an apparatus for transmitting a scheduling request according to yet another example of the present disclosure; and

FIG. 4 is a schematic structural diagram of UE according to an example of the present disclosure.

### DETAILED DESCRIPTION

The examples of the present disclosure are described in detail below, samples of the examples are shown in the drawings, where the same or similar labels throughout represent the same or similar elements or elements with the same or similar functions. The examples described below with reference to the drawings are exemplary and merely used for explaining the present disclosure, but cannot be interpreted as a limitation on the present invention.

Those skilled in the art may understand that the singular forms “one”, “one piece”, “said” and “the” used here may also include the plural forms, unless specifically stated. It should be further understood that the phrase “including” used in the specification of the present disclosure refers to the existence of the features, integers, steps, operations, elements and/or components, but does not exclude the existence or addition of one or more other features, integers, steps, operations, elements, components and/or groups thereof. It should be understood that when it is said that an element is “connected” or “coupled” to another element, the element may be directly connected or coupled to other elements, or there may be intermediate elements. In addition, the “connection” or “coupling” used here may include wireless connection or wireless coupling. The phrase “and/or” used here includes all or any unit and all combinations of one or more associated listed items.

Unless otherwise defined, all terms (including technical terms and scientific terms) used here have the same meaning as the general understanding of those of ordinary skill in the art to which the present disclosure belongs. The “user equipment”, “terminal” and “terminal equipment” used here include equipment provided with wireless signal receivers, which is equipment provided with wireless signal receivers without transmission capability, and also include equipment provided with receiving and transmitting hardware, which is equipment provided with receiving and transmitting hardware capable of carrying out two-way communication in a two-way communication link. The equipment may include: cellular equipment or other communication equipment, which is cellular equipment or other communication equipment provided with single-line displays or multi-line displays or without the multi-line displays; personal communications service (PCS) systems, which are capable of combining voice, data processing, fax and/or data communication capabilities; personal digital assistants (PDAs), which may include radio-frequency receivers, pagers, Internet/intranet access, web browsers, notepads, calendars and/or global positioning system (GPS) receivers; and conventional laptop computers and/or palmtop computers or other equipment, which are conventional laptop computers and/or palmtop computers or other equipment provided with and/or including radio-frequency receivers. The “terminal”, “terminal equipment” and “user equipment” used here may be portable, transportable, installed in (aerial, marine and/or land) transportation means, or may be suitable for running locally and/or be configured to run locally, and/or run at any other position in the earth and/or a space in a distributed form. The “terminal”, “terminal equipment” and “user equipment” used here may also be communication terminals, Internet terminals, and music/video playing terminals, such as PDAs, mobile Internet devices (MIDs) and/or mobile phones with music/video playing functions, or may be smart TVs, set-top boxes and other equipment.

The present disclosure relates to the technical field of wireless communication, and particularly relates to a method and an apparatus for transmitting a scheduling request, user equipment, and a non-transitory computer-readable storage medium.

In a 5G system, there are service types that require high reliability and low latency (i.e., ultra-reliability low latency communication (URLLC) service) and service types that do not require high reliability and low latency but require a relatively large data transmission rate (i.e., enhanced mobile broadband (eMBB) service). For different types of services, transmission priorities of the services are different, so that a base station may configure SR resources with different priority levels for UE respectively. However, when the UE is configured with a plurality of sets of SR configurations with different priority levels, if there is a time domain overlap existing between SR resources carrying scheduling requests (SRs) and PUCCH resources carrying other UCI (such as HARQ-ACK and/or CSI) information, the UE may not reasonably transmit the SR information.

In order to better understand the solutions provided by the examples of the present disclosure, the following first describes the technical terms and related technologies involved in the present disclosure.

Noun Introduction

Uplink control information (UCI): refers to control signaling of an uplink layer 1/layer 2, and the UCI usually includes:

a scheduling request (SR): is signaling for applying to a base station for uplink wireless resource configuration by user equipment (UE);

hybrid automatic repeat request (HARQ) response (ACK/NACK) information of downlink data transmission, where if a terminal correctly demodulates downlink data, ACK response information is fed back to the base station through uplink control signaling, otherwise NACKX information is fed back; and

channel state information (CSI): is information reflecting a channel state between the base station and the terminal (user equipment (UE)).

physical uplink control information (PUCCH): is used for carrying uplink control information, and mainly includes CQI, ACK, etc.

physical uplink shared channel (PUSCH): is used for carrying uplink data, and includes service data, high-level signaling, etc.

positive SR and negative SR: the positive SR means that the user equipment requests uplink resources from the base station, while the negative SR means that the user does not request the uplink resources.

In a communication protocol of 5G R15, the base station may configure a plurality of sets of PUCCH resources (hereinafter also called SR resources) for carrying the SR requests for the UE. Each set of the SR resources for carrying the SR requests may refer to a set of the PUCCH resources which are fixed in a frequency domain and periodically occur in a time domain. There may or may not be actual SR transmission in a SR resource. If the PUCCH resources carrying HARQ-ACK or CSI information overlap with K PUCCH resources configured to carry SR resources (regardless of whether there is actual SR transmission or not) in a time domain, UCI in the PUCCH channels overlapped in the time domain should be multiplexed, that is, the UCI in the plurality of PUCCHs overlapped in the time domain is carried into one PUCCH. When the UCI is multiplexed, the binary number of the K SRs is changed into ┌log₂(K+1)┐ bits, and the ┌log₂(K+1)┐ bits may be combined with HARQ-ACK information bits and/or CSI bits in a certain order to form a bit string for transmission, however, in the transmission process, the UE can only transmit any one of the K SRs randomly and cannot transmit according to the priority levels for the SRs. Thus, the SR information cannot be reasonably transmitted, and then the transmission efficiency cannot be increased.

With regard to the above problems in the related art, the examples of the present disclosure provide a method for transmitting scheduling requests. On the basis of the solutions provided in the examples of the present disclosure, the problem that the UE cannot reasonably transmit the SR information can be solved.

In order to make the purpose, technical solutions and advantages of the present disclosure clearer, optional implementation manners of the present disclosure and how the technical solutions of the examples of the present disclosure solve the above technical problems will be described in detail below in combination with the specific examples and drawings. The following specific examples may be combined with each other, and the same or similar concepts or processes may not be repeated in some examples. The examples of the present disclosure will be described below in combination with the drawings.

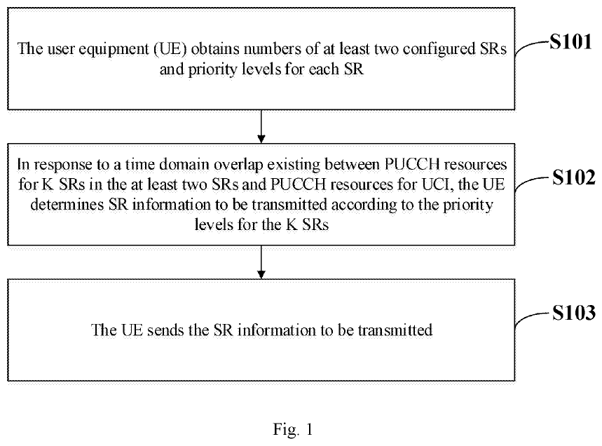

FIG. 1 is a schematic flow diagram of a method for transmitting a scheduling request according to an example of the present disclosure.

Referring to FIG. 1, the method for transmitting a scheduling request includes:

Step S101: user equipment (UE) obtains numbers of at least two configured SRs and priority levels for each SR.

In an example, in the step S101, in response to being accessed to a cell, the UE obtains information which is configured for the at least two SRs by a base station, from the base station, and the SR request configuration information may include numbers of the SRs and priority levels for the SRs.

Step S102: in response to a time domain overlap existing between a physical uplink control channel (PUCCH) resource for K SRs in the at least two SRs and a PUCCH resource for uplink control information (UCI), the UE determines SR information to be transmitted according to the priority levels for the K SRs.

The K is a positive integer greater than one.

In an example, the UCI may include at least one of hybrid automatic repeat request confirmation (HARQ-ACK) information or channel state information (CSI).

In an example, the step of determining SR to be transmitted according to the priority levels for the K SRs may include: the user equipment may determine the SR with the highest priority level and transmitting positive SR information in the K SRs as the SR information to be transmitted according to the priority levels for the K SRs.

In an example, in the step S102, when PUCCH resources for K SRs in the PUCCH resources for transmitting the SRs overlap with the PUCCH resources for transmitting other UCI in a time domain and the K SRs are positive SRs (that is, the user equipment does request the base station to send uplink data), the user equipment may determine the SR to be transmitted according to the priority levels for the SRs configured for the UE by the base station, that is, the user equipment determines the SR that needs to be transmitted preferentially or have a high priority level, or the SR for service that requires high reliability or low latency (for example, ultra-reliability low latency communication (URLLC) service).

Step S103: the UE sends the SR information to be transmitted.

In an example, in the step S103, the UE may indicate the SR information to be transmitted by a binary number with ┌log₂(K+1)┐ bits, for example, the binary number with ┌log₂(K+1)┐ bits may be determined as the SR information to be transmitted.

In an example, in response to at least two SRs with the highest priority level and transmitting the positive SR information, determining any one of the SRs with the highest priority level and transmitting the positive SR information as the SR information to be transmitted.

In an example, in response to the same priority level for the SRs transmitting the positive SR information in the K SRs, any one of the SRs transmitting the positive SR information is determined as the SR information to be transmitted.

In an example, the sequence of the number of the SR to be transmitted in the numbers of the K SRs is indicated by a binary number with ┌log₂(K+1)┐ bits, the SR to be transmitted is the SR with the highest priority level and transmitting the positive SR information in the K SRs, and the binary number is determined as the SR information to be transmitted.

For example, if a total of 8 SRs need to be transmitted, the 8 SRs are sequentially numbered as SR configuration ID 0 to SR configuration ID 7, and moreover, in the 8 SRs that need to be transmitted, PUCCH resources for K=3 SRs overlap with PUCCH resources for transmitting other UCI in a time domain, the corresponding numbers of the overlapped K=3 SRs are SR configuration ID 3, SR configuration ID 4, and SR configuration ID 7, the UE first renumbers the overlapped K SRs according to the configuration IDs of the overlapped K SRs. For example, referring to a corresponding relationship between the SR configuration IDs and SR index order IDs in Table 1, the UE renumbers the overlapped K SRs as SR index order 1 (corresponding to the SR configuration ID 3), SR index order 2 (corresponding to the SR configuration ID 4), and SR index order 3 (corresponding to the SR configuration ID 7), then the UE determines whether the K=3 SRs are positive SRs or not, then the UE chooses the SR with the highest priority level in the SRs that are determined as the positive SRs, and finally, the UE indicates the SR with the highest priority level and determined as the positive SR by using ┌log₂(K+1)┐.

For example, if the above SR index order 1, SR index order 2, and SR index order 3 are determined as the SRs that are all the positive SRs and have the highest priority level according to the priority levels for the SRs configured by the base station, the UE indicates any one of the SRs that are determined as the positive SRs and have the highest priority level in a preset indication manner, for example, by ┌log₂(K+1)┐, that is, the UE may choose to indicate any one of the SRs corresponding to the SR index order 1, the SR index order 2, and the SR index order 3. In the example, since K=3, ┌log₂(K+1)┐=┌log₂(3+1)┐=2 bits, the UE indicates any one of the SRs corresponding to the SR index order 1, the SR index order 2, and the SR index order 3 by using 2-bit information. That is, the two bits may be 01, 10 or 11.

### Table 1 Corresponding Relationship Between SR Configuration ID and SR Index Order ID

| SR | SR | SR |
|---|---|---|
| configuration | configuration | configuration |
| ID 3 | ID 4 | ID 7 |
| SR index | SR index | SR index |
| order 1 | order 2 | order 3 |

In another example, if a total of 8 SRs need to be transmitted, the 8 SRs are sequentially numbered as SR configuration ID 0 to SR configuration ID 7, and moreover, if in the 8 SRs that need to be transmitted, PUCCH resources for K=5 SRs overlap with PUCCH resources for transmitting other UCI in a time domain, for example, the SR configuration IDs corresponding to the K=5 SRs are SR configuration ID 2, SR configuration ID 3, SR configuration ID 5, SR configuration ID 6, and SR configuration ID 7 respectively, then the UE needs to renumber the SR configuration ID 2, SR configuration ID 3, SR configuration ID 5, SR configuration ID 6, and SR configuration ID 7 firstly. For example, by referring to a corresponding relationship between the SR configuration IDs and SR index order IDs in Table 2, the UE renumbers the K=5 SRs as SR index order 1 to SR index order 5.

### Table 2 Corresponding Relationship Between SR Configuration ID and SR Index Order ID

| SR | SR | SR | SR | SR |
|---|---|---|---|---|
| configuration | configuration | configuration | configuration | configuration |
| ID2 | ID3 | ID5 | ID6 | ID7 |
| SR index | SR index | SR index | SR index | SR index |
| order 1 | order 2 | order 3 | order 4 | order 5 |

After that, the UE needs to first determine whether the SR index order 1 to the SR index order 5 are the positive SRs or not:

Table 3 shows a corresponding relationship between the SR configuration IDs and the SR index order IDs, and whether the SRs are the positive SRs or negative SRs. Referring to Table 3, if the UE determines that only the SR corresponding to the SR index order 4 is the positive SR, the UE may indicate the SR corresponding to the SR index order 4 by using ┌log₂(K+1)┐, that is, since K=5, ┌log₂(K+1)┐=┌log₂(5+1)┐=3 bits, so that the UE indicates the SR corresponding to the SR index order 4 by using 3-bit information, that is, the 3-bit information may be set to be 100.

TABLE 3

| SR | SR | SR | SR | SR |
|---|---|---|---|---|
| configuration | configuration | configuration | configuration | configuration |
| ID2 | ID3 | ID5 | ID6 | ID7 |
| SR index | SR index | SR index | SR index | SR index |
| order 1 | order 2 | order 3 | order 4 | order 5 |
| negative SRs | negative SRs | negative SRs | positive SRs | negative SRs |

Table 4 shows a corresponding relationship between the SR configuration IDs and the SR index order IDs, whether the SRs are the positive SRs or the negative SRs, and the priority levels for the SRs. Referring to Table 4, if the UE determines that the SRs corresponding to the SR index order 4 and the SR index order 5 are both the positive SRs (that is, at least two SRs are the positive SRs) and the SRs corresponding to the SR index order 4 and the SR index order 5 both have the highest priority level, that is, at least two SRs are the positive SRs and have the highest priority level, the UE indicates any one of the SRs corresponding to the SR index order 4 and the SR index order 5, which are both the positive SRs and have the highest priority level, by using ┌log₂(K+1)┐=┌log₂(5+1)┐=3 bits, that is, the 3-bit information may be set to be 100 or 101.

TABLE 4

| SR | SR | SR | SR | SR |
|---|---|---|---|---|
| configuration | configuration | configuration | configuration | configuration |
| ID2 | ID3 | ID5 | ID6 | ID7 |
| SR index | SR index | SR index | SR index | SR index |
| order 1 | order 2 | order 3 | order 4 | order 5 |
| negative SRs | negative SRs | negative SRs | positive SRs | positive SRs |
| low priority | low priority | low priority | the highest | the highest |
| level | level | level | priority level | priority level |

Table 5 shows a corresponding relationship between the SR configuration IDs and the SR index order IDs, whether the SRs are the positive SRs or the negative SRs, and the priority levels for the SRs. Referring to Table 5, if the UE determines that one or more of the three SRs corresponding to the SR index order 1 to the SR index order 3 are the positive SRs, and the two SRs corresponding to the SR index order 4 and the SR index order 5 are the negative SRs, but the SRs corresponding to the SR index order 4 and the SR index order 5 have high priority levels, and the three SRs corresponding to the SR index order 1 to the SR index order 3 have low priority levels lower than the high priority levels, in this case, the UE indicates any one of the three SRs corresponding to the SR index order 1 to the SR index order 3, which are the positive SRs, by using 3 bits.

TABLE 5

| SR | SR | SR | SR | SR |
|---|---|---|---|---|
| configuration | configuration | configuration | configuration | configuration |
| ID2 | ID3 | ID5 | ID6 | ID7 |
| SR index | SR index | SR index | SR index | SR index |
| order 1 | order 2 | order 3 | order 4 | order 5 |
| positive SRs | positive SRs | positive SRs | negative SRs | negative SRs |
| low priority | low priority | low priority | high priority | high priority |
| level | level | level | level | level |

Table 6 shows a corresponding relationship between the SR configuration IDs and the SR index order IDs, and whether the SRs are the positive SRs or negative SRs. Referring to Table 6, if the UE determines that the five SRs corresponding to the SR index order 1 to the SR index order 5 are not the positive SRs, the values of the ┌log₂(K+1)┐=┌log₂(5+1)┐=3 bits are all set to be 0.

TABLE 6

| SR | SR | SR | SR | SR |
|---|---|---|---|---|
| configuration | configuration | configuration | configuration | configuration |
| ID2 | ID3 | ID5 | ID6 | ID7 |
| SR index | SR index | SR index | SR index | SR index |
| order 1 | order 2 | order 3 | order 4 | order 5 |
| negative SRs | negative SRs | negative SRs | negative SRs | negative SRs |

In an example, the UE not only sends the SR information to be transmitted to the base station, but also sends other UCI to the base station together, the specific implementation manner may be combining the bits of the other UCI with the bits of indication information of the corresponding SRs into a bit string, and the bit string is sent to the base station.

In an example, the method for sending the bit string includes the following four cases:

Case 1: when there is a time domain overlap a between physical uplink control channel (PUCCH) resource for K SRs in the at least two SRs and a PUCCH resource for HARQ-ACK information bits, if the UE needs to transmit Q_{HARQ-ACK} bits and ┌log₂ (K+1)┐ SR information bits in the PUCCH resources, the UCI bits that may be sent to the base station by the UE through the PUCCH resources are Q_{UCI}=Q_{HARQ-ACK}┌log₂(K+1)┐ UCI bits in total, that is, the ┌log₂(K+1)┐ SR information bits are attached behind the HARQ-ACK information bits to form a character string, and the character string is sent to the base station.

Case 2: when there is a time domain overlap between physical uplink control channel (PUCCH) resources for K SRs in the at least two SRs and PUCCH resources for CSI bits, if the UE needs to transmit Q_{CSI} bits and ┌log₂(K+1)┐ SR information bits in the PUCCH resources, the UCI bits that may be sent to the base station by the UE through the PUCCH resources are Q_{UCI}=┌log₂(K+1)┐+Q_{CSI}, that is, the ┌log₂(K+1)┐ bits are attached in front of the Q_{CSI} bits to form a character string, and the character string is sent to the base station.

Case 3: when there is a time domain overlap between physical uplink control channel (PUCCH) resources for K SRs in the at least two SRs, and PUCCH resources for HARQ-ACK information bits and CSI bits, if the UE needs to transmit Q_{HARQ-ACK} bits, Q_{CSI} bits and ┌log₂(K+1)┐ SR information bits in the PUCCH resources, the UCI bits that may be sent to the base station by the UE through the PUCCH resources are Q_{UCI}=Q_{HARQ-ACK}+┌log₂(K+1)┐+Q_{CSI}, that is, the ┌log₂(K+1)┐ bits are attached behind the HARQ-ACK information bits and in front of the CSI bits, that is to say, the ┌log₂(K+1)┐ bits are inserted between the HARQ-ACK information bits and the CSI bits, then a character string is formed, and the character string is sent to the base station.

Case 4: if there are no SRs to be transmitted in the K SR resources, that is, the SRs are all the negative SRs, the ┌log₂(K+1)┐ bits are all set to be 0.

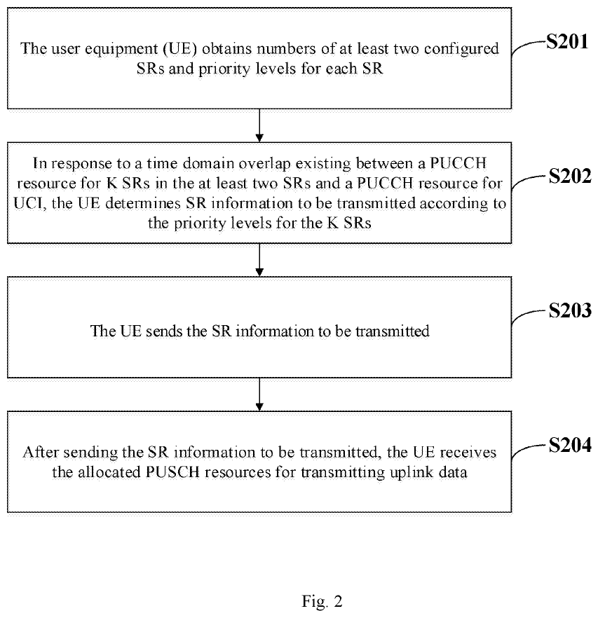

FIG. 2 is a schematic flow diagram of a method for transmitting a scheduling request according to another example of the present disclosure.

Referring to FIG. 2, the method for transmitting a scheduling request of the present disclosure may include the following steps:

S201: user equipment (UE) obtains numbers of at least two configured SRs and a priority level for each SR.

S202: in response to a time domain overlap existing between a physical uplink control channel (PUCCH) resource for K SRs in the at least two SRs and a PUCCH resource for uplink control information (UCI), the UE determines SR information to be transmitted according to the priority levels for the K SRs.

K is a positive integer greater than one.

S203: the UE sends the SR information to be transmitted.

S204: after sending the SR information to be transmitted, the UE receives the allocated PUSCH resources for transmitting uplink data.

In step S204, the UE sends information including the SR information to be transmitted and determined in step S202, to the base station, and the base station allocates the PUSCH resources for transmitting uplink data to the UE so that the UE carries out uplink data transmission later.

In the examples of the present disclosure, the UE indicates the scheduling requests with high priority levels in a predetermined indication manner, so that the UE may reasonably transmit the scheduling requests that need to be transmitted preferentially, then the base station may allocate the PUSCH resources for uplink data to the UE preferentially for executing uplink data transmission, so that the efficiency of data transmission is increased.

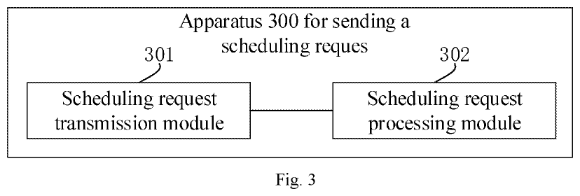

On the basis of the same principle as the method provided in the examples of the present disclosure, the examples of the present disclosure further provide an apparatus for sending a scheduling request. FIG. 3 is a schematic structural diagram of an apparatus for transmitting a scheduling request according to yet another example of the present disclosure.

Referring to FIG. 3, the apparatus for transmitting a scheduling request of the examples of the present disclosure includes a scheduling request transmission module 301 and a scheduling request processing module 302, where

scheduling request transmission module 301, used for obtaining numbers of at least two configured SRs and priority levels for each SR;

the scheduling request processing module 302 is used for, in response to a time domain overlap existing between a physical uplink control channel (PUCCH) resource for K SRs in the at least two SRs and a PUCCH resource for uplink control information (UCI), determining SR information to be transmitted according to the priority levels for the K SRs, where K is a positive integer greater than one; and

the scheduling request transmission module 301 is further used for sending the SR information to be transmitted.

In an example, the SR information to be transmitted includes the number of the SR information to be transmitted.

In an example, the scheduling request processing module 302 is used for: determining the SR with the highest priority level and transmitting positive SR information in the K SRs as the SR information to be transmitted according to the priority levels for the K SRs.

In an example, the scheduling request processing module 302 is used for: in response to at least two SRs with the highest priority level and transmitting the positive SR information, determining any one of the positive SRs with the highest priority level as the SR information to be transmitted.

In an example, the scheduling request processing module 302 is used for: in response to the same priority level for the SRs transmitting the positive SR information in the K SRs, determining any one of the SRs transmitting the positive SR information as the SR information to be transmitted.

In an example, the scheduling request processing module is used for: indicating the sequence of the number of the SR to be transmitted in the numbers of the K SRs by means of a binary number with ┌log₂(K+1)┐ bits, the SR to be transmitted being the SR with the highest priority level and transmitting the positive SR information in the K SRs, and determining the binary number as the SR information to be transmitted.

In an example, in response to no positive SR information in the K SRs, the values of the ┌log₂(K+1)┐ bits are set to be 0.

In an example, the scheduling request transmission module 301 is used for: after sending the SR information to be transmitted, receiving the allocated PUSCH resources for transmitting uplink data.

The present disclosure further provides a non-transitory computer-readable storage medium, where a computer program is stored in the non-transitory computer-readable storage medium, and when the computer program is run by the user equipment, the user equipment executes the method for transmitting a scheduling request, where the method for transmitting a scheduling request is described in the first aspect.

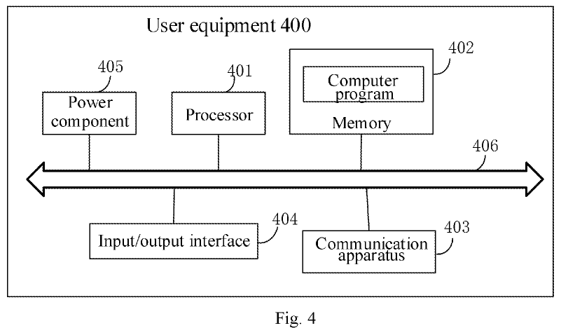

As an example, FIG. 4 shows a schematic structural diagram of user equipment applicable to the examples of the present disclosure, the user equipment may be realized as direct communication user equipment, such as a smart phone, and the user equipment may be used for implementing the method for transmitting a scheduling request according to any alternative example of the present disclosure.

As shown in FIG. 4, the user equipment 400 may mainly include at least one processor 401, a memory 402, a communication interface 403, an input/output interface 404, a power component 405, and other components. The components may implement connection and communication through a bus 406.

In an example, the power component 405 is used for providing the user equipment 400 with a working power supply, and the power component may include, but is not limited to, a rechargeable battery, a charging interface, a charging protection circuit, etc.

The memory 402 may be used for storing a computer program and the like, the computer program may include program codes or instructions for implementing the method shown in the examples of the present disclosure while being called by the processor 401, and may further include programs for realizing other functions or services.

The memory 402 may be a read-only memory (ROM) or other types of static storage equipment capable of storing static information and instructions, a random access memory (RAM) or other types of dynamic storage equipment capable of storing information and instructions, or an electrically erasable programmable read-only memory (EEPROM), a compact disc read-only memory (CD-ROM) or other optical disc storages, optical disk storages (including compact disks, laser disks, optical disks, digital universal disks, blue-ray disks, etc.), magnetic disc storage media or other magnetic storage equipment, or any other media that can be used for carrying or storing desired program codes in the form of instructions or data structures and can be accessed by computers, but is not limited thereto.

The processor 401 is connected with the memory 402 through the bus 406, and implements the corresponding functions by calling the application programs stored in the memory 402. The processor 401 may be a central processing unit (CPU), a general processor, a digital signal processor (DSP), an application-specific integrated circuit (ASIC), a field-programmable gate array (FPGA) or other programmable logic devices, transistor logic devices, hardware components or any combination thereof. The processor 401 may implement or execute various exemplary logical blocks, modules, and circuits described in combination with the contents disclosed by the present disclosure. The processor 401 may also be a combination for implementing calculation functions, for example, the processor 401 may include one or more microprocessor combinations, a combination of a DSP and a microprocessor, etc.

The communication apparatus 403 may allow the user equipment 400 to communicate with other user equipment wirelessly or through a wire to exchange data, for example, the user equipment 400 sends direct communication data through the communication apparatus, and may receive data (or instructions, etc.) sent by the base station or other user equipment. The communication apparatus 403 may include, but is not limited to, part or all of receivers, transmitters, wired network interfaces, wireless network interfaces, antennas, and the like.

The user equipment 400 may be connected with needed input/output equipment, such as external storage apparatuses, charging equipment, and the like, through the input/output interface 404, so that data in the user equipment 400 may be stored into the other storage apparatuses, or data in the other storage apparatuses may be stored into the user equipment 400. It may be understood that the input/output interface 404 may be a wired interface or a wireless interface.

The bus 406 for connecting the components may include a path for transmitting information among the above components. The bus 406 may be a peripheral component interconnect (PCI) bus or an extended industry standard architecture (EISA) bus, etc. According to different functions, the bus 406 may be divided into an address bus, a data bus, a control bus, etc.

Alternatively, for the solutions provided in the examples of the present disclosure, the memory 402 may be used for storing the application program codes for executing the solutions of the present disclosure, and the execution is controlled by the processor 401. The processor 401 is used for executing the application program codes stored in the memory 402 to implement action of the method or apparatus according to the examples of the present disclosure.

It should be understood that although the steps in the flowcharts of the drawings are sequentially displayed as indicated by arrows, the steps are not sequentially executed necessarily as indicated by the arrows. Unless explicitly stated in this document, the execution of the steps is not strictly limited in order, and the steps may be executed in other order. Moreover, at least a part of the steps in the flowcharts of the drawings may include a plurality of sub-steps or stages, the sub-steps or stages are not completed at the same time necessarily, but may be executed at different times, and the execution order is not necessarily sequential, but the sub-steps or stages may be executed in turn or alternately with other steps or at least a part of the sub-steps or stages of the other steps.

The above are merely part of the examples of the present disclosure, it should be noted that, for those of ordinary skill in the art, several improvements and modifications may be made without departing from the principle of the present disclosure, and the improvements and modifications should also fall within the protection scope of the present disclosure.

In a first aspect, a method for transmitting a scheduling request (SR) is provided, and the method includes: obtaining numbers of at least two configured SRs and a priority level for each SR; in response to a time domain overlap existing between a physical uplink control channel (PUCCH) resource for K SRs in the at least two SRs and a PUCCH resource for uplink control information (UCI), determining SR information to be transmitted according to the priority levels for the K SRs, where K is a positive integer greater than one; and sending the SR information to be transmitted.

In an example, the determining SR information to be transmitted according to the priority levels for the K SRs includes: determining the SR, with the highest priority level, transmitting positive SR information in the K SRs as the SR information to be transmitted according to the priority levels for the K SRs.

In an example, in response to at least two SRs with the highest priority level and transmitting the positive SR information, determining any one of the SRs with the highest priority level, transmitting the positive SR information as the SR information to be transmitted.

In an example, the determining SR information to be transmitted according to the priority levels for the K SRs includes: in response to the same priority level for the SRs transmitting the positive SR information in the K SRs, determining any positive SR with the highest priority level as the SR information to be transmitted.

In an example, the sequence of the number of the SR to be transmitted in the numbers of the K SRs is indicated by a binary number with ┌logₑ (K+1)┐ bits, the SR to be transmitted is the SR with the highest priority level, transmitting the positive SR information in the K SRs, and the binary number is determined as the SR information to be transmitted.

In an example, in response to no positive SR information in the K SRs, the values of the ┌log₂(K+1)┐ are set to be 0.

In a second aspect, an apparatus for transmitting a scheduling request is provided, and the apparatus includes a scheduling request transmission module and a scheduling request processing module, where

the scheduling request transmission module is used for obtaining numbers of at least two configured SRs and priority levels for each SR;

the scheduling request processing module is used for, in response to a time domain overlap existing between a physical uplink control channel (PUCCH) resource for K SRs in the at least two SRs and a PUCCH resource for uplink control information (UCI), determining SR information to be transmitted according to the priority levels for the K SRs, where K is a positive integer greater than one; and

the scheduling request transmission module is further used for sending the SR information to be transmitted.

In an example, the scheduling request processing module is used for: determining the SR with the highest priority level and transmitting positive SR information in the K SRs as the SR information to be transmitted according to the priority levels for the K SRs.

In an example, the scheduling request processing module is used for: in response to at least two SRs with the highest priority level and transmitting the positive SR information, determining any positive SR with the highest priority level as the SR information to be transmitted.

In an example, the scheduling request processing module is used for: in response to the same priority level for the SRs transmitting the positive SR information in the K SRs, determining any one of the SRs transmitting the positive SR information as the SR information to be transmitted.

In an example, the scheduling request processing module is used for: indicating the sequence of the number of the SR to be transmitted in the numbers of the K SRs by means of a binary number with ┌log₂(K+1)┐ bits, the SR to be transmitted being the SR with the highest priority level, transmitting the positive SR information in the K SRs, and determining the binary number as the SR information to be transmitted.

In an example, in response to no positive SR information in the K SRs, the values of the ┌log₂(K+1)┐ bits are set to be 0.

In a third aspect, user equipment (UE) is provided, and the user equipment includes a memory and a processor, where the memory and the processor are communicatively coupled,

a computer program is stored in the memory; and

the processor is used for executing the method for transmitting a scheduling request, where the method for transmitting a scheduling request is described in the first aspect, when the computer program is run.

In a fourth aspect, a non-transitory computer-readable storage medium is provided, where a computer program is stored in the non-transitory computer-readable storage medium, and when the computer program is run by user equipment, the user equipment executes the method for transmitting a scheduling request, where the method for transmitting a scheduling request is described in the first aspect.

The beneficial effects brought by the technical solutions provided by the present disclosure are as follows:

the present disclosure provides a method for transmitting a scheduling request, in the case that the UE is configured with scheduling requests with different priority levels, the scheduling requests with high priority levels are indicated to the base station in a specific indication manner, and thus the problem that the UE cannot reasonably transmit the scheduling requests is solved.

1. A method for transmitting a scheduling request (SR), performed by user equipment (UE), the method comprising:
determining numbers of at least two configured SRs and a priority level for each SR;
determining SR information to be transmitted according to the priority levels for K SRs, wherein K is a positive integer greater than one, and a time domain overlap existing between a physical uplink control channel (PUCCH) resource for the K SRs in the at least two configured SRs and a PUCCH resource for uplink control information (UCI); and
sending the SR information to be transmitted.

2. The method according to claim 1, wherein determining the SR information to be transmitted according to the priority levels for the K SRs comprises:
determining the SR, with the highest priority level, transmitting positive SR information in the K SRs as the SR information to be transmitted according to the priority levels for the K SRs.

3. The method according to claim 2, wherein
determining any one of the positive SRs with the highest priority level is the SR information to be transmitted, wherein there have at least two SRs with the highest priority level for transmitting the positive SR information.

4. The method according to claim 1, wherein determining the SR information to be transmitted according to the priority levels for the K SRs comprises:
determining any one of the SRs transmitting positive SR information as the SR information to be transmitted, wherein the SRs transmitting the positive SR information in the K SRs have a same priority level.

5. The method according to claim 1, wherein determining the SR information to be transmitted comprises:
indicating a sequence of a number of the SR to be transmitted in the numbers of the K SRs by a binary number with ┌log₂(K+1)┐ bits, wherein the SR to be transmitted being the highest priority level for transmitting the positive SR information in the K SRs, and determining the binary number as the SR information to be transmitted.

6. The method according to claim 5, wherein there is no positive SR information in the K SRs, and values of the ┌log₂(K+1)┐ bits are set to be 0.

7-12. (canceled)

13. User equipment (UE), comprising a memory and a processor, wherein the memory and the processor are communicatively coupled, and
a computer program is stored in the memory; wherein
the processor is configured to:
determine numbers of at least two configured SRs and a priority level for each SR; determine SR information to be transmitted according to the priority levels for K SRs, wherein K is a positive integer greater than one, and a time domain overlap existing between a physical uplink control channel (PUCCH) resource for the K SRs in the at least two SRs and a PUCCH resource for uplink control information (CCI); and
send the SR information to be transmitted.

14. A non-transitory computer-readable storage medium, wherein a computer program is stored in the computer-readable storage medium, and when the computer program is run by user equipment (UE), executes:
determining numbers of at least two configured SRs and a priority level for each SR;
determining SR information to be transmitted according to the priority levels for K SRs, wherein K is a positive integer greater than one, and a time domain overlap existing between a physical uplink control channel (PUCCH) resource for the K SRs in the at least two SRs and a PUCCH resource for uplink control information (UCI); and
sending the SR information to be transmitted.

15. The non-transitory computer-readable storage medium according to claim 14, wherein the computer program further executes:
determining the SR, with the highest priority level, transmitting positive SR information in the K SRs as the SR information to be transmitted according to the priority levels for the K SRs.

16. The non-transitory computer-readable storage medium according to claim 15, wherein the computer program further executes:
determining any one of the positive SRs with the highest priority level is the SR information to be transmitted, wherein there have at least two SRs with the highest priority level for transmitting the positive SR information.

17. The non-transitory computer-readable storage medium according to claim 14, wherein the computer program further executes:
determining any one of the SRs transmitting the positive SR information as the SR information to be transmitted, wherein the SRs transmitting the positive SR information in the K SRs have a same priority level.

18. The non-transitory computer-readable storage medium according to claim 14, wherein the computer program further executes:
indicating a sequence of a number of the SR to be transmitted in the numbers of the K SRs by a binary number with ┌log₂(K+1)┐ bits, wherein the SR to be transmitted being the highest priority level for transmitting the positive SR information in the K SRs, and
determining the binary number as the SR information to be transmitted.

19. The non-transitory computer-readable storage medium according to claim 18, wherein there is no positive SR information in the K SRs, and the values of the ┌log₂(K+1)┐ bits are set to be 0.

20. The user equipment (UE) according to claim 13, wherein the processor is further configured to:
determine the SR, with the highest priority level, transmitting positive SR information in the K SRs as the SR information to be transmitted according to the priority levels for the K SRs.

21. The user equipment (UE) according to claim 20, wherein the processor is further configured to:
determine any one of the positive SRs with the highest priority level is the SR information to be transmitted, wherein there have at least two SRs with the highest priority level for transmitting the positive SR information.

22. The user equipment (UE) according to claim 13, wherein the processor is further configured to:
determine any one of the SRs transmitting the positive SR information as the SR information to be transmitted, wherein the SRs transmitting the positive SR information in the K SRs have a same priority level.

23. The user equipment (UE) according to claim 13, wherein the processor is further configured to:
indicate a sequence of a number of the SR to be transmitted in the numbers of the K SRs by a binary number with ┌log₂(K+1)┐ bits, wherein the SR to be transmitted is the highest priority level for transmitting the positive SR information in the K SRs, and determine the binary number as the SR information to be transmitted.

24. The user equipment (UE) according to claim 23, wherein there is no positive SR information in the K SRs, and values of the ┌log₂(K+1)┐ bits are set to be 0.
